(19) United States
(12) Patent Application Publication
(10) Pub. No.: US 2016/0176448 A1
(43) Pub. Date: Jun. 23, 2016

(54) TONNEAU PANEL LOCKING FEATURE

(71) Applicant: Laurmark Enterprises, Inc., Ann Arbor, MI (US)

(72) Inventors: DAVID GERMANO, Ann Arbor, MI (US); James HOWELL, Iola, TX (US)

(21) Appl. No.: 14/844,040

(22) Filed: Sep. 3, 2015

Related U.S. Application Data
(60) Provisional application No. 62/093,583, filed on Dec. 18, 2014.

(51) Int. Cl. B62D 33/04; B60J 7/14; B60P 7/02

(52) U.S. Cl. CPC B62D 33/046; B60P 7/02; B60J 7/141

(57) ABSTRACT

A tonneau cover for a cargo box having a plurality of panel sections foldable between a deployed arrangement, wherein the panel sections are generally coplanar for covering the cargo box, and a folded arrangement, wherein the panel sections are folded in a compact configuration. The panel sections each includes a rigid panel member having an outer face, an inner face, and a panel edge therebetween, and an edge strip defining a channel receiving the panel edge. The edge strip includes an inner side overlying the inner face of the panel section and an outer side overlying the outer face of the panel section. At least one of the inner side and the outer side includes a protrusion engaging an adjacent margin of the inner face and/or outer face to retain the edge strip to the rigid panel member.

### CROSS-REFERENCE TO RELATED APPLICATIONS

This application claims the benefit of U.S. Provisional Application No. 62/093,583, filed on Dec. 18, 2014. The entire disclosure of the above application is incorporated herein by reference.

### FIELD

The present disclosure relates to coverings for cargo boxes and, more particularly, relates to a tonneau cover having an edge strip including a protrusion to secure the edge strip to a rigid panel member

### BACKGROUND AND SUMMARY

This section provides background information related to the present disclosure which is not necessarily prior art. This section further provides a general summary of the disclosure, and is not a comprehensive disclosure of its full scope or all of its features.

Tonneau covers have been used for a number of years to cover the cargo box of pickup trucks against dirt, debris, and other environmental contaminants and to improve the aesthetic quality thereof. Originally, tonneau covers were designed by upholstery shops and typically made of vinyl covered fabrics or canvas. The material was often doubled over along its edges for added strength and appearance. Male snaps were then attached to the sides of the cargo box of the pickup truck via fasteners, while female snaps were attached along the edges of the cover. Wooden bows were sometimes used to span the cargo box and ensure that the cover remained high enough to drain water. Unfortunately, these covers were sometimes difficult to handle and/or manufacture, and occasionally failed to protect the cargo box.

More recently, foldable tonneau covers are often more desirable in that they conveniently cover the cargo box of the pickup truck for cargo protection. However, when not in use, the foldable tonneau cover may be folded toward the rear of the passenger cabin (or other location). Generally, foldable tonneau covers include a multi-panel system, a latching system for coupling the multi-panel system to the pickup truck and a means for stowing the latching system, and a hinge system for hingedly coupling adjacent sections of the multi-panel system.

Conventionally, tonneau covers often include a plurality of panel sections which each includes an edge strip extending along at least one edge or perimeter of each respective panel section. Traditionally, this edge strip is an extrusion and is typically glued along the panel section to fasten the edge strip to the panel section and provide a protective edge along the panel section. During manufacturing, this extruded edge strip is glued to the panel and the combination edge strip and panel are stored nearby for a sufficient time before handling to allow the glue to cure. Handling of the panel and edge strip prior to sufficient glue cure may result in damage to the panel assembly, reduced bonding strength, and increased panel assembly scrap.

Generally, such curing stage requires that the assembled panel and extruded edge strip be cured for hours in a climate controlled facility. This often occurs in the assembly area and consumes enormous floor space that could otherwise be used for increased manufacturing capacity and/or efficiency.

Accordingly, there is a need in the relevant art to provide a tonneau cover that can include the protective edge strip, without requiring excessive curing and/or storing time and space. That is, there exists a need in the relevant art to provide a panel section formed of an edge strip coupled to a rigid panel that can be handled promptly after assembly for subsequent manufacturing operations without requiring delay or storage. Finally, there exists a need in the relevant art to overcome the disadvantages of the prior art.

According to the principles of the present teachings, a tonneau cover for a cargo box is provided having an advantageous construction. The tonneau cover includes a plurality of panel sections foldable between a deployed arrangement, wherein the panel sections are generally coplanar for covering the cargo box, and a folded arrangement, wherein the panel sections are folded in a compact configuration. The panel sections each include a rigid panel member having an outer face, an inner face, and a panel edge therebetween, and an edge strip defining a channel receiving the panel edge. The edge strip includes an inner side overlying the inner face of the panel section and an outer side overlying the outer face of the panel section. At least one of the inner side and the outer side includes a protrusion engaging an adjacent margin of the inner face and/or outer face to retain the edge strip to the rigid panel member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view illustrating a folding tonneau cover according to the principles of the present teachings positioned upon a cargo box of a pickup truck in a deployed arrangement;

FIG. 1B is a perspective view illustrating the folding tonneau cover according to the principles of the present teachings positioned in a folded or stowed arrangement;

FIG. 2 is a plan view illustrating the folding tonneau cover according to the principles of the present teachings;

FIG. 3 is a cross-sectional view the panel section in FIG. 4 prior to assembly of a rigid panel member into an edge strip according to the principles of the present teachings;

FIG. 4 is a cross-sectional view of a panel section of the folding tonneau in FIGS. 1 and 2, taken along the lines 4-4 in the direction of the arrows;

FIG. 5 is an enlarged cross-sectional view taken from the area 5 of FIG. 4 illustrating the rigid panel, edge strip, and film being restrained by a protrusion;

FIG. 6 is a cross-sectional view illustrating a rigid panel member and an edge strip according to some alternate embodiments;

FIG. 7 is a cross-sectional view illustrating the rigid panel member and edge strip having a film disposed therebetween and opposing protrusions according to other alternate embodiments;

FIG. 8 is a cross-sectional view illustrating the rigid panel member and edge strip according to still other embodiments;

FIG. 9 is a cross-sectional view illustrating the rigid panel member and edge strip according to still other embodiments;

FIG. 10 is a cross-sectional view illustrating the rigid panel member and edge strip having a triangular protrusion according to some embodiments;

FIG. 11 is a cross-sectional view illustrating the rigid panel member and edge strip having an arcuate protrusion according to some embodiments; and

FIG. 12 is a cross-sectional view illustrating the rigid panel member and edge strip having a flat-contact protrusion according to some embodiments.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

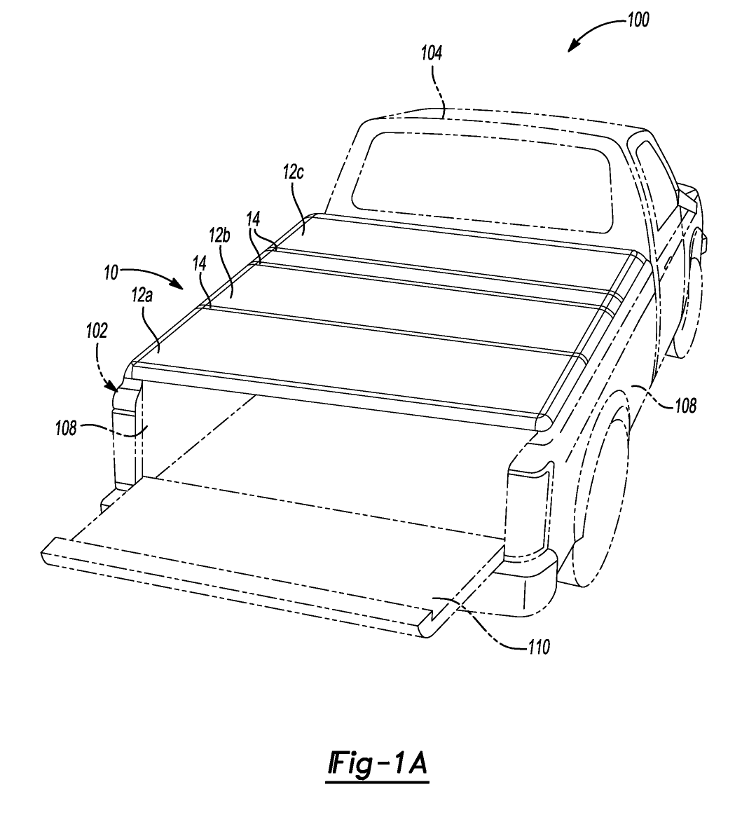

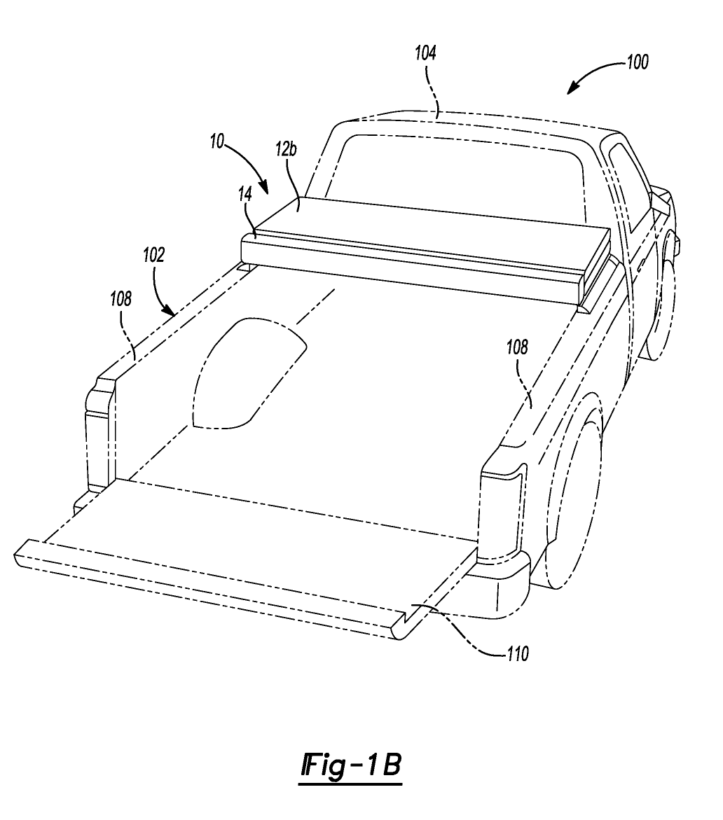

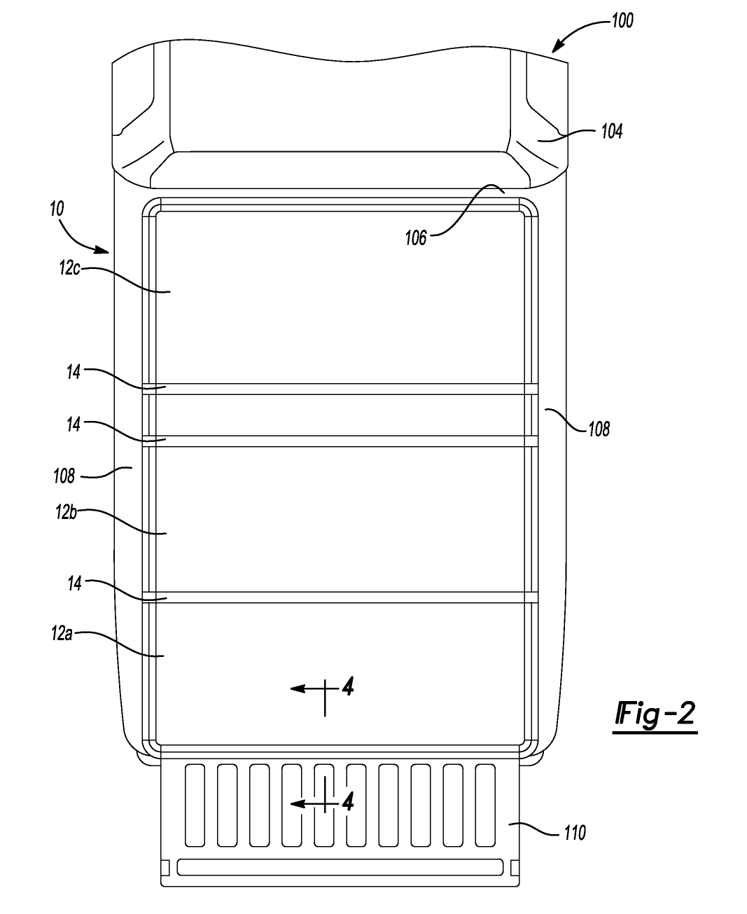

With reference to FIGS. 1A, 1B, and 2, a pickup truck 100 is shown having a foldable tonneau cover 10 for use with pickup truck 100. Pickup truck 100 generally includes a cargo box 102 and a passenger cabin 104. Cargo box 102 includes a front wall 106, a pair of sidewalls 108, and a rear wall or tailgate 110. It should be understood that the pair of sidewalls 108 includes a left sidewall and a right sidewall that are generally identical, yet arranged in mirrored symmetry.

Referring now to FIGS. 1A, 1B, and 2, foldable tonneau cover 10 includes, in some embodiments, a plurality of hard tonneau panel sections 12a, 12b, 12c hingedly coupled together via hinges 14 that collectively form a top surface spanning or otherwise covering cargo box 102 of pickup truck 100. In some embodiments, the plurality of panel sections 12 are foldable between a deployed arrangement or position wherein the panel sections are generally coplanar for covering the cargo box 102 (see FIG. 1A) and a folded or stowed arrangement or position wherein the panel sections 12 are folded in a compact configuration to reveal the cargo box (see FIG. 1B).

Although the present embodiment will be described in connection with three panel sections 12, it should be understood that the principles of the present invention are equally applicable to foldable tonneau covers having two, three, four, or more panel sections. However, for purposes of this disclosure, a foldable tonneau cover 10 having three panel sections 12a, 12b, and 12c will be described. This configuration should not be regarded as limiting the claims herein. Panel sections 12a-12c may be referred to herein as first panel section 12a, second panel section 12b, and third panel section 12c.

Generally, first panel section 12a, is the most rearward panel section relative to the pickup truck 100 adjacent tailgate 110 of cargo box 102. Second panel section 12b is positioned forward of first panel section 12a relative to the pickup truck 100. Finally, third panel section 12c is positioned forward of second panel section 12b relative to the pickup truck 100. In the present embodiment, third panel section 12c is located adjacent front wall 106 of cargo box 102, such that second panel section 12b is located between first panel section 12a and third panel section 12c, thereby spanning cargo box 102 and providing a cover thereon.

In some embodiments, one or more of first panel section 12a, second panel section 12b, and third panel sections 12c are configured to be coupled to sidewalls 108 of cargo box 102 to retain foldable tonneau cover 10 in engagement with pickup truck 100. Third panel section 12c is configured to be coupled to at least one of front wall 106 and sidewalls 108 of cargo box 102 to retain third panel section 12c in coupled engagement with pickup truck 100. In some embodiments, as described herein, third panel section 12c can be pivotally coupled to front wall 106 of cargo box 102.

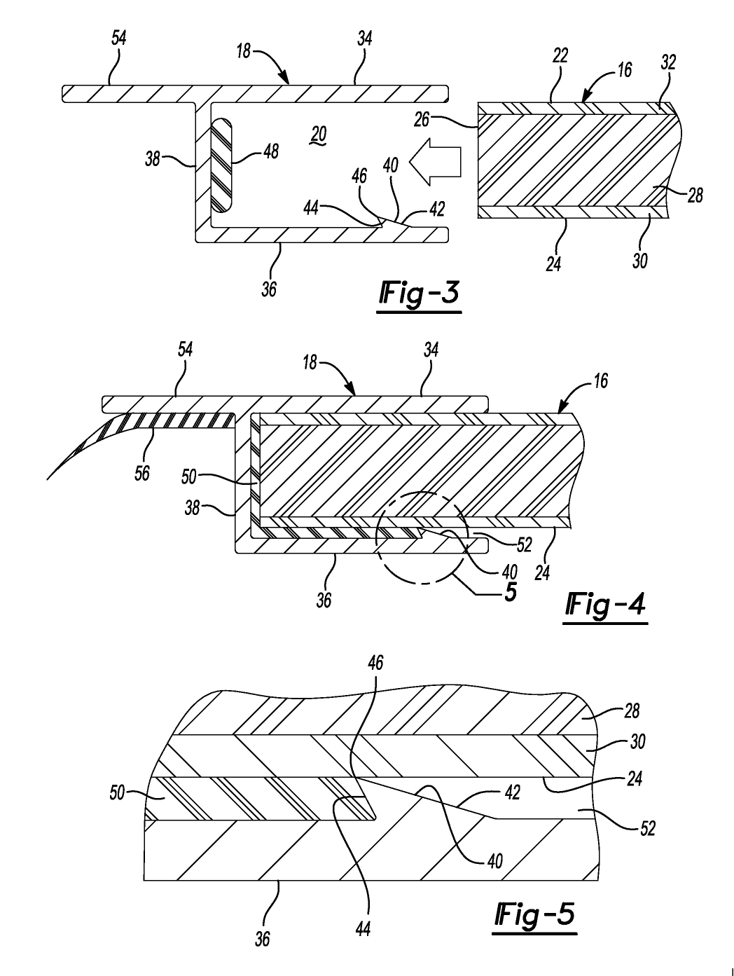

In some embodiments as illustrated in FIGS. 3-12, each of the plurality of panel sections 12a-12c includes a generally rigid rectangular panel member 16 having edge strips 18 that together generally form a rectangular frame. Referring to FIGS. 3-5, panel section 12a can comprise rigid panel member 16 that is planar and comprises a first or top face 22, a second or bottom face 24 opposite first face 22, and a panel edge 26 extending therebetween and about the periphery of panel member 16. Referring to FIGS. 3 and 4, in some embodiments, panel member 16 comprises a central core 28. Core 28 may be suitably formed of a polymeric material, such as a polypropylene or polystyrene foam material. Alternately, core 28 may be formed of aluminum or other suitable metal, and may have a lightweight honeycomb structure. Rigid panel member 16 may also comprise an inner surface film or layer 30 and an outer surface film or layer 32, which may be suitably formed of a polymeric material, such as fiberglass reinforced plastic material, thermoplastic olefin material, or aluminum or other metal.

In some embodiments, as illustrated in FIGS. 3-5, a panel section 12 comprises edge strip 18 affixed to a margin of panel member 16. Edge strip 18 can define a U-shaped channel 20 having a first or upper outer side 34 that faces outside when the cover is in the deployed position, a second or inner side 36 disposed within the cargo bed when the cover is in the deployed position, and an interconnecting member 38 extending between outer side 34 and inner side 36. Sides 34 and 36 are arranged substantially parallel and interconnecting member 38 is arranged substantially orthogonal to sides 34 and 36.

In some embodiments, inner side 36 of edge strip 18 comprises a protrusion 40 disposed on the inner surface to engage bottom face 24 of panel member 16. Referring to FIG. 5, there is shown a protrusion 40 having a generally triangular shape and has a side 42 facing the open end of U-shaped channel 20 and a side 44. Side 42 is elongated to provide a gentle slope, whereas side 44 extends at an acute angle to create an undercut. Referring to FIG. 3 depicting panel member 16 and edge strip 18 during assembly, an advantage of the triangular profile of protrusion 40 is to facilitate insertion of the panel in U-shaped channel 20. Following assembly, point 46 of protrusion 40 presses into bottom face 24 to resist withdrawal of the panel member 16 from the U-shaped channel 20. Also, prior to assembly, a bead 48 of sealant and/or adhesive is applied within U-shaped channel 20. Bead 48 is composed of a liquid or flowable substance that flows during insertion to form film 50 in FIG. 4. Bead 48 may be formed of an adhesive bonding agent that bonds panel member 16 to edge strip 18 and concurrently forms a seal to prevent water leakage therebetween. Alternately, bead 48 may be formed of a material that forms a seal without bonding the members. As shown in FIGS. 4 and 5, a gap 52 is formed between bottom face 24 and inner side 36 of edge strip 18 as a result of protrusion 40. Despite gap 52, protrusion 40 can form a dam to contain the flow of bead 48. Moreover, top face 22 of panel member 16 and outer side 34 of edge strip 18 are coplanar and abut in intimate contact to prevent the flow of material therebetween, and further without a gap that would otherwise collect water or dirt therebetween. Thus, in the embodiment in FIG. 3, the location of protrusion 40 against the bottom face 24 enhances assembly by resisting withdrawal of panel member 16 from U-shaped channel 20, particularly in embodiments that use an adhesive agent that requires time for setting, and provides an aesthetically pleasing appearance by preventing seepage of the material from the joint.

In some embodiments, protrusions 40 can be extruded as part of edge strips 18 to form an integral member being made of a single material. In some embodiments, however, protrusion 40 can be formed of a material that is different from the material of edge strip 18, such as via co-extrusion. By way of non-limiting example, in some embodiments, edge strip 18 can be made of aluminum having a polymeric protrusion 40. In some embodiments, edge strip 18 can be made of a first polymer and protrusion 40 can be made of a second polymer that is different from the first polymer. Moreover, in some embodiments, edge strip 18 can be made of a first material that is covered with a second material that forms both a covering or skin on edge strip 18 and the shape of protrusion 40.

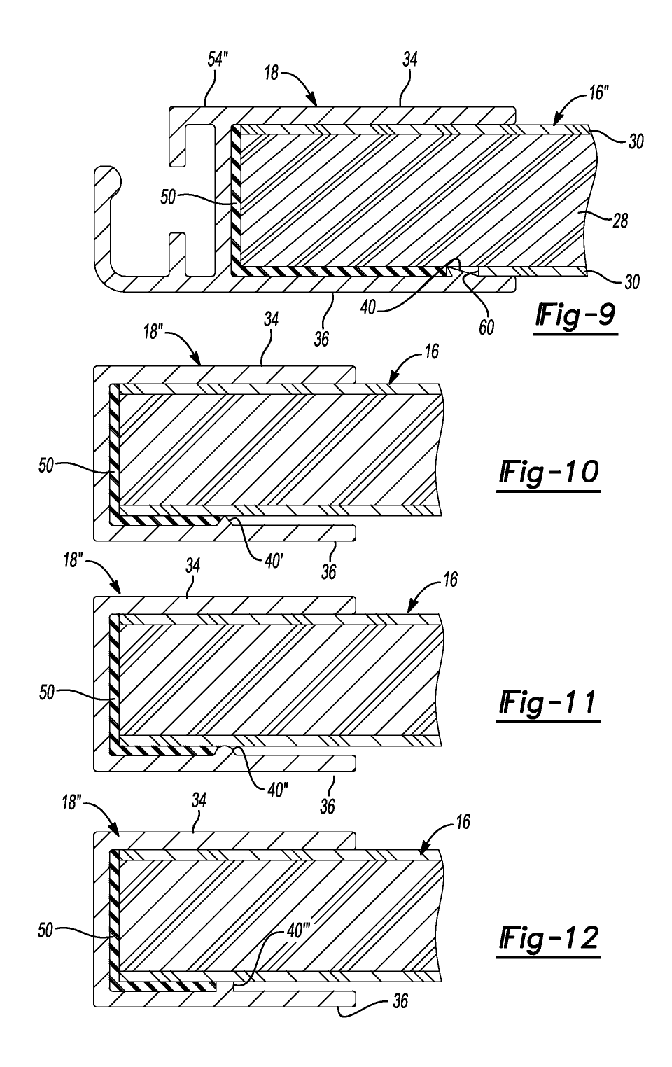

In some embodiments in FIGS. 3-5, edge strip 18 is adapted for use adjacent a rear edge of the tonneau cover that lies adjacent the tailgate and includes a flange 54 to which a seal strip 56 is adhesively bonded, for forming a seal with the tailgate. In alternate configurations, the edge strip 18 may include an outboard structure that defines a slot for receiving a sealing strip, such as flange 54′ in FIG. 7, of the type typically employed adjacent a sidewall 108. In still other embodiments, the edge strip 18 may include an outboard structure such as flange 54″ in FIG. 9, such as may be utilized adjacent a hinge between panel sections.

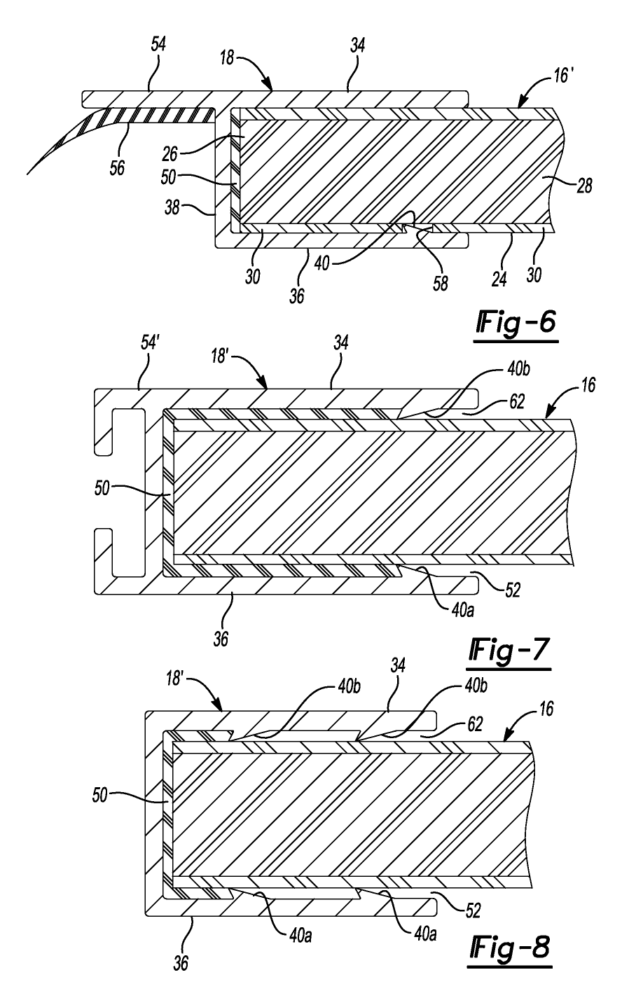

Referring now to FIG. 6, there is shown a panel member 16′ coupled to edge strip 18. In accordance with this embodiment, inner surface layer 30 includes a slot 58 for receiving protrusion 40. As a result of slot 58, resistance to withdrawal of panel member 16′ from edge strip 18 is increased, and further gap 52 (see FIGS. 4 and 5) between bottom face 24 and inner side 36 is reduced, thereby providing a strong and aesthetically pleasing assembly. In this embodiment, film 50 can be generally contained along panel edge 26.

Referring now to FIG. 9, there is shown a panel member 16″ coupled to edge strip 18. In accordance with this embodiment, inner surface layer 30 terminates at a position or edge 60 generally adjacent protrusion 40 and thus does not extend toward panel edge 26. As a result, protrusion 40 engages and retains panel member 16″ through mechanical engagement of point 46 of protrusion 40 and central core 28 of panel member 16″. Similar to the embodiment of FIG. 6, gap 52 between bottom face 24 and inner side 36 is reduced, thereby providing a strong and aesthetically pleasing assembly. In this embodiment, film 50 is permitted to flow along panel edge 26 and along a bottom side of central core 28 providing increased contact area for improved sealing and/or bonding.

Referring now to FIGS. 7 and 8, there is shown panel member 16 coupled to an edge strip 18′ having a plurality of protrusions 40. In accordance with these embodiments, the plurality of protrusions 40 can be positioned along only one of outer side 34 and inner side 36, or both. In particular, protrusions 40 can include inner protrusions 40a positioned along inner side 36 of edge strip 18′ that engage bottom face 24 of panel member 16. Similarly, protrusions 40 can include outer protrusions 40b positioned along outer side 34 of edge strip 18′ that engage top face 22 of panel member 16. As a result of the plurality of protrusions 40, gap 52 can be formed between bottom face 24 and inner side 36 of edge strip 18′ and gap 62 can be formed between top face 22 and outer side 34 of edge strip 18′. Protrusions 40a and 40b can form a dam to contain the flow of bead 48, thereby limiting film 50. It should be understood that the plurality of protrusions 40 (e.g. 40a and 40b) can vary in size and shape such that they define discrete profiles.

Referring now to FIGS. 10-12, there is shown panel member 16 coupled to an edge strip 18″ having protrusions 40 defining alternative cross-sectional profiles. Specifically, with reference to FIG. 10, protrusion 40′ comprises a triangular shape having sides both forming obtuse angles. This arrangement can result in an isosceles triangle forming a robust configuration resistant to breakage and providing increased mechanical engagement. With reference to FIG. 11, protrusion 40″ comprises an arcuate shape having sloping or curved sides. This arrangement can result in a gentle slope facilitating engagement with panel member 16, while also providing increased contact surface area to enhance frictional engagement with panel member 16. With reference to FIG. 12, protrusion 40″′ comprises a flat or rectangular shape contact area having generally orthogonal sides. This arrangement can result in still further increased contact surface area to enhance frictional engagement with panel member 16. It should be appreciated that alternative cross-sectional profiles are anticipated, such as profiles combining various features of protrusions 40, 40′, 40″, 40″′ (e.g. sloped or arcuate side facing open end of channel with flat contact surface and undercut side).

Accordingly, the present teachings enable edge strips 18 to be readily installed on panel member 16 (with or without adhesive or other agent). The edge strips include protrusions that assist in retaining the strip on the panel member to resist dislodging during subsequent handling. As a result, in embodiments using an adhesive to permanently bond the edge strip and panel member, the assembly can be handled prior to setting of the adhesive, eliminating the time and floor space that would otherwise be required for storing the panel during curing. Thus, the combination assembly can be directly handled and subjected to further assembly and manufacturing operations without delay, thereby reducing cost and increasing efficiency.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tonneau cover for covering a cargo box, the tonneau cover comprising:
a plurality of panel sections foldable between a deployed arrangement wherein the panel sections are generally coplanar for covering the cargo box and a folded arrangement wherein the panel sections are folded in a compact configuration, the panel sections comprising:
a rigid panel member having an outer face, an inner face, and a panel edge therebetween; and
an edge strip defining a channel receiving the panel edge and including an inner side overlying the inner face and an outer side overlying the outer face, at least one of the inner side and the outer side comprising a protrusion engaging an adjacent margin of the at least one of the inner face and the outer face.

2. The tonneau cover according to claim 1 wherein the inner face is adapted to face the cargo box when the tonneau cover is in the deployed arrangement and wherein the inner face includes an inner margin adjacent the panel edge, and wherein the protrusion engages the inner margin.

3. The tonneau cover according to claim 1 wherein the inner face is adapted to face the cargo box when the tonneau cover is in the deployed arrangement and includes an inner margin adjacent the panel edge, and the outer face is opposite the inner face and includes an outer margin adjacent the panel edge, and wherein the protrusion is disposed on the inner side of the edge strip and engages the inner margin, and wherein the outer side is in intimate contact with the outer margin.

4. The tonneau cover according to claim 1 wherein the inner face is adapted to face the cargo box when the tonneau cover is in the deployed arrangement and includes an inner margin adjacent the panel edge, and the outer face is opposite the inner face and includes an outer margin adjacent the panel edge, and wherein the protrusion is a first protrusion disposed on the inner side of the edge strip and engages the inner margin, and wherein the edge strip includes a second protrusion disposed on the outer side and engaging the outer margin.

5. The tonneau cover according to claim 1 wherein the protrusion is a tooth having a generally triangular cross-section that includes a point contacting the adjacent margin.

6. The tonneau cover according to claim 1 wherein the edge strip is an extrusion and wherein the protrusion is integrally formed with the extrusion.

7. The tonneau cover according to claim 1, further comprising:
a film between the rigid panel member and the edge strip, the film being formed of a material selected from the group consisting of an adhesive and a sealant.

8. The tonneau cover according to claim 7, wherein the protrusion prevents the spread of the film beyond the margin.

9. A tonneau cover for covering a cargo box, the tonneau cover comprising:
at least one panel section comprising:
a panel member having a first face, a second face, and a panel edge therebetween; and
an edge strip defining a channel receiving the panel edge and including a first side overlying the first face of the panel and a second side overlying the second face of the panel, at least one of the first side and the second side comprising a protrusion engaging an adjacent margin of the at least one of the first face and the second face to retain the edge strip to the panel member.

10. The tonneau cover according to claim 9 wherein the first face of the panel is adapted to face the cargo box and wherein the first face of the panel includes a first margin adjacent the panel edge, and wherein the protrusion engages the first margin.

11. The tonneau cover according to claim 9 wherein the first face of the panel includes a first margin adjacent the panel edge, and the second face of the panel is opposite the first face of the panel and includes a second margin adjacent the panel edge, and wherein the protrusion is disposed on the first side of the edge strip and engages the first margin, and wherein the second side of the edge strip is in intimate contact with the second margin.

12. The tonneau cover according to claim 9 wherein the first face of the panel includes a first margin adjacent the panel edge, and the second face of the panel is opposite the first face of the panel and includes a second margin adjacent the panel edge, and wherein the protrusion is a first protrusion disposed on the first side of the edge strip and engages the first margin, and wherein the edge strip includes a second protrusion disposed on the second side and engaging the second margin.

13. The tonneau cover according to claim 9 wherein the protrusion is a tooth having a generally triangular cross-section that includes a point contacting the adjacent margin.

14. The tonneau cover according to claim 9 wherein the protrusion is a plurality of protrusions having varying cross-sectional sizes.

15. The tonneau cover according to claim 9 wherein the edge strip is an extrusion and wherein the protrusion is integrally formed with the extrusion.

16. The tonneau cover according to claim 9, further comprising:
a film between the panel member and the edge strip, the film being formed of an adhesive material or a sealant material.

17. The tonneau cover according to claim 9, further comprising:
a film between the panel member and the edge strip, the film being a sealant.

18. The tonneau cover according to claim 17, wherein the protrusion prevents the spread of the film beyond the margin.

19. The tonneau cover according to claim 9 wherein the edge strip is made of a first material and the protrusion is made of a second material, the second material being different from the first material.

20. The tonneau cover according to claim 9 wherein the margin comprises a depression receiving the protrusion.
